(19) United States
(12) Patent Application Publication
(10) Pub. No.: US 2022/0294310 A1
(43) Pub. Date: Sep. 15, 2022

(54) ELECTRIC MOTOR FOR ELECTRIC VEHICLE

(71) Applicant: TEXA DYNAMICS S.R.L, Monastier di Treviso (IT)

(72) Inventor: Bruno VIANELLO, Monastier di Treviso (IT)

(21) Appl. No.: 17/639,648

(22) PCT Filed: Sep. 1, 2020
(86) PCT No.: PCT/IB2020/058123

§ 371 Date: Mar. 2, 2022

(30) Foreign Application Priority Data
Sep. 2, 2019 (IT) 102019000015406

(51) Int. Cl. H02K 7/102; H02K 11/33

(52) U.S. Cl. CPC H02K 7/1023; H02K 11/33

(57) ABSTRACT

An electric motor is described comprising a central stator and a rotor formed by an outer casing of the motor. A ring is integral with the outer surface of the casing and a braking member integral with the stator can to brake the ring. An electronic circuit mounted on/in the stator generates a resistant torque to brake the rotor through the motor acting as brake and the braking member.

The invention refers to an electric motor for an electric vehicle and the vehicle comprising the motor, in particular a braking system and more specifically a vehicle with a double braking system.

Electric vehicles typically use an electric motor for propulsion and regenerative braking that converts the vehicle's kinetic energy into electrical energy. However, for practical reasons the full braking torque through regenerative braking alone is insufficient, and an additional friction-based braking system is required.

GB2472392 illustrates a vehicle with a hybrid braking system, regenerative braking and electromechanical braking. Embedded inside each wheel is an electric motor controlled via bus by an external master controller. The master controls the operation of the electric motors of the drive wheels, and may force them to generate a regenerative braking torque. Coupled to each wheel is also a mechanical friction-based braking disc, which can be engaged by a caliper electrically driven by an electric control signal emitted via bus by a braking controller in turn controlled by the master device.

The electronic structure of the master device and the braking controller is very complex.

In addition, installing the motor in the drive wheel increases its weight, with disadvantages for the suspension, and prevents standardization and easy maintenance, since each motor must be designed for the wheel hosting it.

Therefore it is desired to propose a motor and system that improves this state of the art, wherein the system and motor is defined in the attached claims, in which the dependent ones define advantageous variants.

An electric motor is then presented comprising:

a central stator with electric windings for generating a magnetic field that hits the rotor,

the rotor formed by an outer motor casing that is pivoted rotatably about the stator to rotate about an axis,

a ring integral with the outer surface of the casing and placed coaxially to said axis,

a braking member that is integral with the stator and configured to brake the ring, e.g. by tightening the ring,

an electronic circuit mounted on/in the stator comprising:
an electronic power stage to drive the stator windings to control the rotor's rotation,
an electronic control stage for the braking member,
a logic unit (e.g. a microprocessor) configured to control the electronic power stage and the electronic control stage so as to generate a resistant torque to brake the rotor by
   driving the stator windings so that the motor acts as an electric power-generating brake, and
   driving the electronic control stage to activate the braking member on the ring.

The structure of the above mentioned motor is self-sufficient for its control, being equipped with the necessary circuits on board. Therefore the master/slave structure of GB2472392 is avoided.

Besides, the motor is not installed in a drive wheel, with advantage for standardization and easy maintenance. Other advantages concern the fact that the remote position of the motor with respect to the wheel allows not to weigh down the wheel, which being a mass downstream the shock absorber could create destabilization.

The braking member is e.g. an electromechanical member, in particular a caliper; or a pneumatic member, such as a hydraulic caliper.

According to a variant, the logic unit is configured to control the electronic power stage and the electronic control circuit to simultaneously generate the resistant torque via the braking member and the braking action developed by the electric motor. This results in a coordinated action of the braking means. The simultaneous action of the braking member and the braking action developed by the electric motor can take place over the entire duration of the braking or only in a time sub-interval.

According to a variant, the motor comprises a sensor configured to detect the relative position of the braking member with respect to the ring and send to the logic unit a signal indicating the relative position. In this way, a precise, e.g. feedback, positional control can be performed on the braking member.

According to a variant, the logic unit is configured to control the electronic power stage and the electronic control stage so that the resistant torque follows a desired profile over time. The profile may be generated internally within the logic unit or may be contained in a remote signal outside the motor, in particular a signal generated by a braking level sensor that can be operable by a person, such as a brake lever or pedal.

According to a variant, said electronic circuit is mounted inside a fixed casing from which the stator protrudes, for compactness and ease of electrical wiring.

According to a variant, the logic unit is configured to control the electronic power stage so as to impose a driving torque on the rotor, in particular so that the driving torque follows a desired profile over time. The profile may be generated internally in the logic unit or may be contained in a remote signal outside the motor, in particular a signal generated by a speed level sensor operatable by a person, such as a lever or an accelerator pedal.

According to a variant, the outer casing of the motor is finned to dissipate heat.

According to a variant said logical unit is not comprised in the motor but is external to the motor, located in a remote location and connected to the motor via cable or a wireless channel. In this way the control of the motor, or of several motors, can be coordinated by a common control unit.

The invention is directed preferably to an axial-flow electric motor, that is a motor having a stator equipped with windings placed in circular series about said rotation axis. Each winding serves to create a magnetic field, with a polar axis parallel to the rotation axis, through which to set the rotor into rotation thanks to the magnetic interaction between the generated magnetic fields and a corresponding circular series of magnetic elements of the rotor. This type of motor has a more complex structure than radial-flux motors but is lighter and smaller the power being the same. In particular, the stator is sandwiched between two rotors axially spaced along the rotation axis.

Another aspect of the invention concerns a vehicle, e.g. a car or a tractor, comprising a motor as defined above to drive and brake a driving wheel of the vehicle.

The advantages of the invention will be clearer from the following description of a preferred embodiment, referring to the attached drawing in which

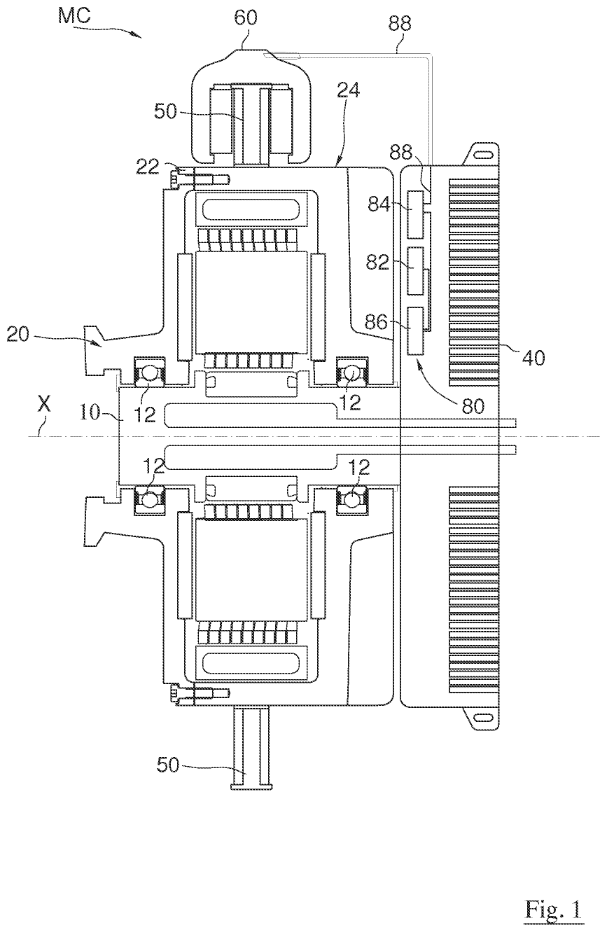

FIG. 1 shows a cross-sectional view of an electric motor.

The motor MC shown in FIG. 1 serves to allow—and also to brake—the rotation of a wheel (not shown) of a vehicle not shown, e.g. a car or a truck.

The motor MC comprises a central stator 10 and a rotor 20 rotatably pivoted via bearings 12 around the stator 10 to rotate about an axis X.

The stator 10, which protrudes from a casing 40, comprises well-known electric windings in order to push the rotor 30 into rotation through a magnetic field generated by the windings.

The rotor 20 comprises an outer casing 22 of the motor MC, e.g. a bell, on whose outer surface 24 a ring 50 is fixed and arranged coaxially to the axis X.

On the ring 50 can act a caliper 60 which is integral with the stator 10 (and/or with the casing 40) and configured to tighten the ring 50.

Inside the casing 40 is placed an electronic circuit 80 composed of
an electronic power stage 82 to drive the stator windings 10,
an electronic control stage 84 to control the caliper 60 via a line 88, e.g. an electrical line;
a microprocessor 86 programmed to control the electronic power stage 82 and the electronic control stage 84.

The microprocessor 86 is programmed in a known way to drive the electronic power stage 82 to rotate the rotor 10. For example, the microprocessor 86 can impose a torque on the rotor 10 following a reference signal, e.g. generated by a speed level sensor that can be operated by a person, such as a lever or an accelerator pedal.

The microprocessor 86 is in particular programmed to drive the electronic power stage 82 and the electronic control stage 84 to brake the rotor 10.

The braking action may be generated by driving the electronic power stage 82 so that the motor MC acts as an electric power-generating brake, and/or by driving the electronic control stage 84 to tighten the caliper 60 on the ring 50.

In the first case, the electric energy generated by the motor MC is derived from the conversion of kinetic energy of the wheel and/or vehicle, and e.g. it can be stored in a battery (not shown).

In the second case the kinetic energy of the wheel and/or vehicle is converted by the friction between the caliper 70 and the ring 60 into heat.

An example of a control algorithm executed by the microprocessor 86 during a braking phase is the following. Defined

RT_Target the braking torque required to the motor MC,

RT_Mmax the maximum braking torque manageable by the motor MC,

RT_Mder the derating torque according to motor/stator temperature,

RT_Bms the braking torque limit determined by the battery charge state,

RT_Rmax the torque limit obtainable by regenerative means,

RT_C the braking torque on the rotor 10 to be applied via the caliper 60,

at each sampling interval (e.g. with a control frequency of 1 KHz) the microprocessor 86 calculates:

RT_Rmax=min{|RT_Mmax|−|RT_Mder|,|RT_Bms|}e

RT_C=min(0,RT_Target−RT_Rmax}.

1. Electric motor comprising:
a central stator with electric windings for generating a magnetic field that hits a rotor, the rotor being formed by an outer casing of the motor which is rotatably pivoted about the stator to rotate about an axis,
a ring integral with the outer surface of the casing and arranged coaxially to said axis,
a braking member which is integral with the stator and configured to brake the ring,
an electronic circuit mounted on/in the stator comprising
an electronic power stage for driving the stator windings to control the rotation of the rotor,
an electronic control stage for the braking member,
a logic unit configured to control the electronic power stage and the electronic control stage so as to generate a resistant torque to brake the rotor by
driving the stator windings so that the motor acts as an electric power-generating brake and
driving the electronic control stage to activate the braking member on the ring to brake the ring.

2. Motor according to claim 1, wherein the braking member is an electromechanical member or a pneumatic member.

3. Motor according to claim 1, wherein the logic unit is configured to control the electronic power stage and the electronic control circuit to simultaneously generate the resistant torque through the braking member and the braking action developed by the electric motor.

4. Motor according to claim 1, wherein the motor comprises a sensor configured
to detect the relative position of the braking member with respect to the ring and
to send to the logic unit a signal indicative of the relative potion.

5. Motor according to claim 1, wherein the logic unit is configured to control the electronic power stage and the electronic control stage so that the resisting torque follows a desired course over time.

6. Motor according to claim 1, wherein said electronic circuit is mounted inside a fixed casing from which the stator protrudes.

7. Motor according to claim 6, wherein the casing is finned to dissipate heat.

8. Motor according to claim 1, wherein the logic unit is configured to control the electronic power stage so as to impose on the rotor a driving torque which follows a desired course over time.

9. Motor according to claim 1, wherein the electric motor is an axial-flow electric motor,
the stator being equipped with windings arranged in a circular series around said rotation axis,
each winding to create a magnetic field, with a polar axis parallel to the rotation axis, through which to rotate the rotor thanks to the magnetic interaction between the generated magnetic fields and a corresponding circular series of magnetic elements of the rotor.

10. Motor according to claim 2, wherein the logic unit is configured to control the electronic power stage and the electronic control circuit to simultaneously generate the resistant torque through the braking member and the braking action developed by the electric motor.

11. Motor according to claim 2, wherein the motor comprises a sensor configured
to detect the relative position of the braking member with respect to the ring and
to send to the logic unit a signal indicative of the relative potion.

12. Motor according to claim 3, wherein the motor comprises a sensor configured
to detect the relative position of the braking member with respect to the ring and
to send to the logic unit a signal indicative of the relative potion.
